(19) United States
(12) Patent Application Publication
(10) Pub. No.: US 2003/0228012 A1
(43) Pub. Date: Dec. 11, 2003

(54) Method and apparatus for efficient use of voice trunks for accessing a service resource in the PSTN

(76) Inventors: L. Lloyd Williams, Kanata (CA); Gordon J. Gilbert, New Market (CA)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/164,088

(22) Filed: Jun. 6, 2002

(51) Int. Cl. H04M 3/42

(52) U.S. Cl. 379/212.01

(57) ABSTRACT

A method and apparatus for efficiently utilizing resources for accessing a service resource in a switched telephone network are described. The service resource is accessed by a calling party who interacts with the service resource, the interaction results in routing information for completing a call. The apparatus includes a call control node that is a virtual switching node in a switching plane of the network and a physical node in a signaling plane of the network. The call control node may be a logical node in a trunk group used to access the service resource. The call control node receives control messages related to calls completed to the service resource. In accordance with the method, the service resource passes routing information to the call control node. The call control node initiates actions to release the facilities used to access the service resource, and to establish a new call connection using the routing information without disconnecting the calling party. An ISUP Release message containing a Service Activation Parameter and a Generic Address Parameter are used for that purpose. The advantages include the ability to offer enhanced services using service resources, while efficiently utilizing facilities in the switched telephone network to ensure access to the service resource and to increase return on investment.

### CROSS-REFERENCE TO RELATED APPLICATIONS

This is the first application filed for the present invention.

### MICROFICHE APPENDIX

Not Applicable.

### TECHNICAL FIELD

This invention relates to the establishment and release of connections in a switched telephone network, and in particular to efficient use of voice trunks for accessing a service resource such as an intelligent peripheral or an application server in a switched telephone network.

### BACKGROUND OF THE INVENTION

Since the introduction of the intelligent telephone network in the early 1980's, there has been an explosion of new services offered in the Public Switched Telephone Network (PSTN). Many of those new services use service resources such as intelligent peripherals or application servers in the course of service delivery. Intelligent peripherals permit the rapid deployment of specialized telephone services which exceed the functional capabilities of the Service Switching Points (SSPs) in the PSTN. Examples of intelligent peripherals used to provide special or enhanced services are taught, for example, in U.S. Pat. No. 5,502,759 entitled APPARATUS AND ACCOMPANYING METHOD FOR PREVENTING TOLL FRAUD THROUGH THE USE OF CENTRALIZED CALLER VOICE VERIFICATION which issued on Mar. 26, 1996 to Chang et al.; U.S. Pat. No. 5,771,273 entitled NETWORK ACCESS PERSONAL SECRETARY which issued on Jun. 23, 1998 to McAllister et al.; and, U.S. Pat. No. 5,729,598 entitled TELEPHONE NETWORK WITH TELECOMMUNICATIONS FEATURES which issued on Mar. 17, 1998 to Kay.

It is common practice to link intelligent peripherals to trunks in the network using Integrated Services Digital Network Primary Rate Interface (ISDN PRI) links through appropriate interface units in the switch. The ISDN links carry both voice and signaling data. Intelligent peripherals are generally used in the network as service resources for providing information preliminary to call completion. In some cases, intelligent peripherals are adapted to complete calls using information obtained in response to input from a calling party. In such cases, a call is forwarded from the intelligent peripheral to a called party. Consequently, two PRI trunks are involved in the call and the call is not optimally routed. Furthermore, ISDN PRI trunks are more expensive to install and maintain than standard ISUP trunks.

There therefore exists a need for a method and apparatus for efficiently using voice trunks for accessing a service resource such as an intelligent peripheral or an application server in the PSTN.

### SUMMARY OF THE INVENTION

It is an object of the invention to provide a method for the efficient use of facilities provided to access a service resource in a switched telephone network.

It is a further object of the invention to provide a method of re-routing a call from a service resource of the switched telephone network without disconnecting the calling party, and without using duplicate or inefficient routing for call completion.

In accordance with one aspect, the invention provides an apparatus for efficiently using voice trunks for accessing a service resource in a switched telephone network.

In accordance with another aspect, the invention provides an apparatus for accessing a service resource in a switched telephone network which enables voice grade ISUP trunks to be terminated on the service resource.

In accordance with yet a further aspect, the invention provides an apparatus for efficiently using voice trunks for accessing a service resource in a switched telephone network in which a call control node provides an interface between the common channel signaling network and the service resource.

Yet a further aspect of the invention provides a method wherein, if the service resource provides information for completing a call elsewhere in the network, the call is released back to an originating switch which establishes the call to be completed elsewhere in the network, thus ensuring the most efficient use of network resources.

The invention further provides a method of efficiently using facilities for providing dial-up access to a service resource in a switched telephone network. The method comprises a first step of receiving information at the service resource from a calling party, the information being related to a service supported by the service resource. The information is translated into routing information that can be used to connect the calling party to a call termination associated with the service. The routing information is transmitted to a call control node in the switched telephone network, the call control node being a virtual switching node in a switching plane and a physical node in a control plane of the switched telephone network. At least one control message is formulated at the call control node to release the facilities used by the calling party to access the service resource, and to connect the calling party to the call termination without disconnecting the calling party from the switched telephone network.

The invention also provides an apparatus for efficiently utilizing dial-up facilities for accessing a service resource in a switched telephone network. The apparatus comprises a call control node in the switched telephone network, the call control node being a virtual node in a switching plane and a physical node in a control plane of the switched telephone network. The call control node is adapted to receive messages containing routing information, to initiate actions to release the facilities utilized by the calling party to access the service resource, and to initiate actions to use the routing information to connect the calling party to a call termination identified by the routing information without releasing the calling party from the switched telephone network. The service resource is adapted to receive information from a user that can be translated into routing information for completing a call between the user and a termination associated with a service supported by the service resource, and to send a message containing the routing information to the call control node.

The invention therefore provides a method and apparatus for the efficient use of voice trunks for accessing a service resource in the PSTN or wireless networks. In accordance with the invention, a service resource such as an intelligent peripheral or an application server is connected to a switch in the PSTN using either ISDN PRI or standard ISUP voice trunks. The Call Control Node (CCN) is logically associated with the voice trunks which terminate on the intelligent peripheral. The CCN is a virtual switching node in the switching plane and a physical node in the common channel signaling plane of the switched telephone network. Consequently, common channel signaling messages related to all calls routed on to the trunks connected to the intelligent peripheral are passed to the CCN.

If the trunks connecting the service resource to an SSP are ISUP trunks, the CCN uses a data link, such as a TCP/IP link to the service resource to instruct it to answer or release calls in response to the receipt of the common channel signaling messages. The TCP/IP link is also used to receive routing information from the service resource. If routing information is received, the CCN formulates an ISUP Release message containing a Service Activation Parameter (SAP) and a Generic Address Parameter (GAP), Nortel's release link trunk implementation, other vendors have similar solutions. The Release message is sent backwards through the network. The effect of the Release message is to release the call back to the originating switch, and the originating switch establishes a new call using the routing information in the GAP. Consequently, calls completed using routing information obtained at the service resource are efficiently completed without use of redundant circuits. Furthermore, facilities used to access the service resource are released to make the resource available to other callers.

The CCN may be a virtual node in any ISUP trunk group in the network through which the call is routed to the service resource. The TCP/IP link is, however, maintained with the service resource so that routing information obtained by the service resource can be passed to the CCN. If the CCN receives routing information from the service resource, the CCN issues an ISUP Release message in the forward direction to release the ISDN PRI trunks for other callers. The CCN also issues a Release message with a SAP and a GAP in the backward direction to release any voice trunks used between an originating SSP and the CCN. The Release message with SAP and GAP causes a new call to be routed through the network from the call originating switch without releasing the calling party. The call is thus most efficiently routed and redundant circuits are eliminated.

### BRIEF DESCRIPTION OF THE DRAWINGS

Further features and advantages of the present invention will become apparent from the following detailed description, taken in combination with the appended drawings, in which:

FIG. 1 is a schematic diagram of a switched telephone network including an apparatus in accordance with a first embodiment of the invention;

FIG. 2 is a call flow diagram schematically illustrating the principal control messages exchanged between components in the switched telephone network illustrated in FIG. 1 when a subscriber accesses a service supported by a service resource in the network configuration shown in FIG. 1;

FIG. 3, which appears on sheet one of the drawings, is a schematic diagram of a switched telephone network including an apparatus in accordance with a second embodiment of the invention; and

FIG. 4 is a schematic call flow diagram of the principal control messages exchanged between elements in the switched telephone network shown in FIG. 3 when a subscriber accesses a service supported by a service resource in the network shown in FIG. 3.

It will be noted that throughout the appended drawings, like features are identified by like reference numerals.

### DETAILED DESCRIPTION OF THE PREFERRED EMBODIMENT

The invention relates to an apparatus and method for the efficient use of resources in a switched telephone network in which service resources such as an application server, interactive voice response unit, intelligent peripheral, or any other call termination node is used as a first stage call processor for routing telephone calls through the switched telephone network. The service resource may interact with callers to determine an appropriate termination for a call. On determination of the appropriate termination, the service resources passes routing information to a Call Control Node (CCN) which releases the call back to an originating switching point in the switched telephone network. The call is re-routed from the originating switching point to the appropriate termination. Resources in the switched telephone network are therefore conserved and duplicate trunk usage is eliminated.

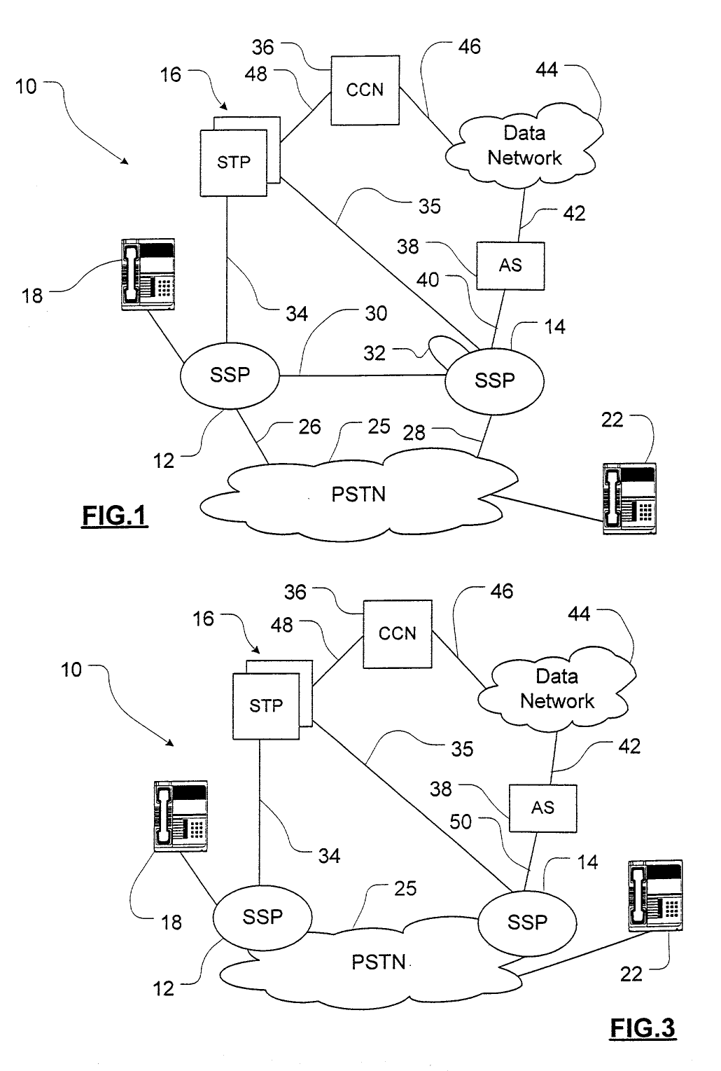

FIG. 1 shows a switched telephone network 10 which includes an apparatus in accordance with the invention. The switched telephone network 10 includes a plurality of switching nodes 12, 14, hereinafter referred to as Service Switching Points (SSPs). The switched telephone network 10 also includes a control network, typically a switched packet common channel signaling network such as Signaling System 7. Packet switches such as a Signal Transfer Point (STP) pair 16 relay control messages between the SSPs 12, 14 over signaling links 34, 35 in a manner well known in the art. The PSTN 10 serves a plurality of subscriber telephones 18, 20, 22 between which connections are effected by the SSPs using time division multiplexed trunks commonly referred to as ISDN User Part (ISUP) trunks 26, 28, and 30. In the network configured in accordance with the invention, a portion of the ISUP trunks are designated as “enhanced” ISUP trunks 30 (EISUP). The EISUP trunks differ from other ISUP trunks in the network in that a Call Control Node (CCN) 36 is configured as a virtual switching node associated with the EISUP trunks 30. Call Control Node (CCN) 36 is connected to the STP pair 16 over signaling links 48. The EISUP trunks may also be loop-back trunks 32, as described in Applicant's co-pending patent application entitled METHOD AND APPARATUS FOR DYNAMICALLY ROUTING CALLS IN AN INTELLIGENT NETWORK, which was filed on Sep. 29, 1997 and has been assigned Serial No. 08/939,909, the specification of which is incorporated herein by reference.

The apparatus shown in FIG. 1 further includes a network service resource such as application server 38, which is well known in the art. The application server 38 is connected to the SSP 14 by an Integrated Services Digital Network Primary Rate Interface (ISDN PRI) trunk facility in a manner well known in the art. The application server 38 also has a data interface which is connected by a data link 42 to a data network 44 which may be, for example, a Local Area Network (LAN) or a Wide Area Network (WAN), and can include the Internet. The data network 44 also supports a data link 46 which connects to a data interface of the CCN 36 to permit CCN 36 to communicate using a data communications protocol such as Transport Control Protocol/Internet Protocol (TCP/IP) with the application server 38.

The application server 38 is used to provide enhanced call services in the PSTN 10. The enhanced call services may be, for example, a voice-dialing feature for a Centrex service supported on SSP 12 for a plurality of business telephones schematically illustrated by telephone 18. The Centrex service provides a virtual Private Branch Exchange (PBX) for one or more business offices which may be geographically dispersed within the area served by the SSP 12. The configuration and operation of Centrex services is well understood by persons skilled in the art and will not be explained.

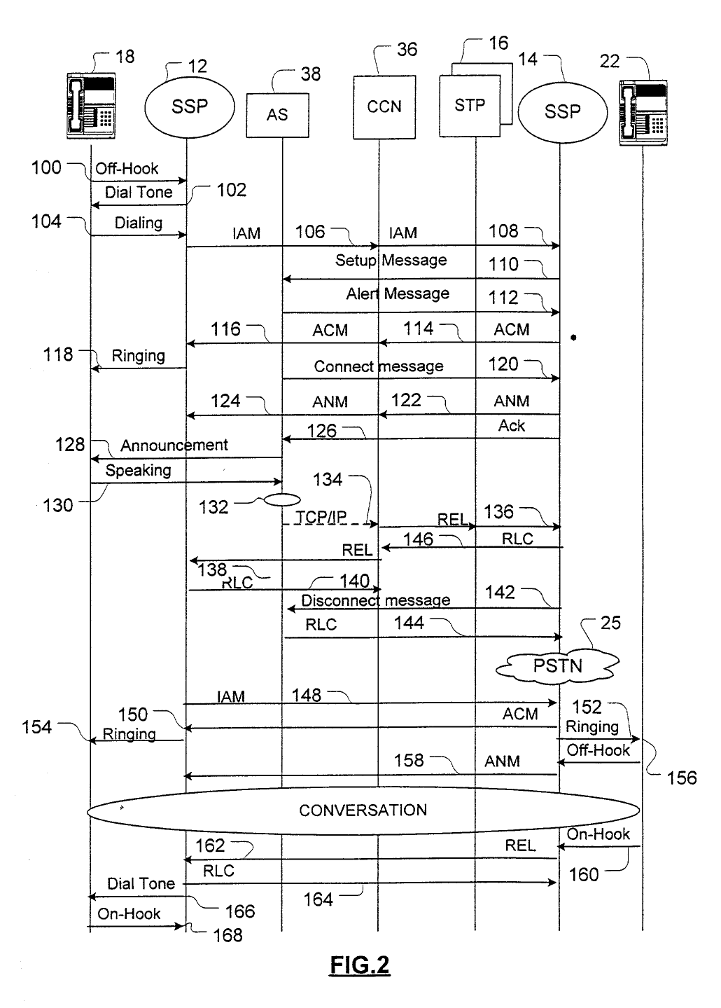

FIG. 2 is a call progress diagram showing the principal steps involved in the setup and teardown of a voice-dialed call initiated from telephone 18, the voice-dialing service being provided by a service resource embodied in application server 38.

As shown in FIG. 2, a Centrex subscriber using telephone 18 takes the phone off-hook (100) to place a voice-dialed call. When the SSP detects the off-hook condition, it returns a dial tone on the Centrex line (102). On receiving the dial tone, the Centrex subscriber telephone 18 presses a speed dial key or any other designated feature button associated with the Centrex service (104). Routing tables in the SSP are configured to route calls associated with the feature to the EISUP trunk group 30 (FIG. 1). Consequently, the SSP 12 formulates an Initial Address Message (IAM). The route sets and link sets associated with the EISUP trunk group 30 direct signaling messages to the CCN 36. Consequently, the IAM is forwarded over signaling links 34, 48 (FIG. 1) to the CCN 36 in step 106. On receipt of the IAM, the CCN 36 simply forwards the message (108) to the SSP 14.

On receipt of the IAM, the SSP forwards an ISDN PRI setup message (110) over a messaging channel of the ISDN trunk 50 to the application server 38. The application server 38 responds to the setup message by returning an Alert message (112) to the SSP 14. On receipt of the Alert message, the SSP 14 returns an Address Complete (ACM) 114 ISUP message to the CCN 36 which forwards the ACM message (116) to the SSP 12. The SSP 12 may apply ringing (118) for the telephone set 118. Meanwhile, the application server 38 forwards a Connect message (120) to the SSP 14 to signal that has answered the call. The SSP 14 responds by formulating an ANM message addressed to the CCN 36. The SSP 14 forwards the ANM message (122) to the CCN 36. The CCN 36 simply forwards the ANM message (124) to the SSP 12. After the ANM message is sent from SSP 12. Meanwhile, the SSP 14 acknowledges the Connect message from the application server 38 by returning an ISDN Acknowledge (Ack) message (126) to the application server 38. This advises the application server 38 that a connection with the calling party is complete. The application server therefore announces its readiness to accept input from the Centrex subscriber at telephone 18 (128). The announcement from the application server may be something as simple as a tone or as complex as a pre-recorded request for the calling party to speak the name of a party to be contacted. On receipt of the announcement, the Centrex subscriber using telephone 18 speaks a name that the subscriber has pre-recorded on the application server 38, using a process well understood in the art (130). On receipt of the speech input, the application server 38 translates the spoken name (132) into routing information, such as a Plain Ordinary Telephone Service (POTS) number. After translation, the application server 38 is programmed to encapsulate the routing information in a TCP/IP message which it forwards through data network 44 over links 42, 46 to the CCN 36 (134). On receipt of the routing information, the CCN 36 formulates a first ISUP Release message which it addresses to the SSP 14 and forwards over signaling link 48 to the STP 16. The STP 16 relays the message over signaling link 35 to the SSP 14 (136). The SSP 14 responds by formulating an RLC message which it returns (146) to the CCN 36. Coincidentally, the CCN formulates a second Release message which contains a Service Activation Parameter (SAP) and a Generic Address Parameter (GAP). The SAP signals the SSP 12 that a new call is to be initiated without release of the Centrex subscriber at telephone 18 and the GAP contains the POTS number supplied by the application server 38 to enable the SSP 12 to initiate the new call. The second Release message is forwarded to the SSP 12 in step 138. On receipt of the second Release message, the SSP 12 formulates a Release Complete message which is returned (140) to the CCN 36. Meanwhile, on receipt of the first REL (136), the SSP 14 formulates an ISDN Disconnect message which it forwards (142) to the application server 38. On receipt of the Disconnect message, the application server 38 returns an ISDN RLC message (144) to the SSP 14, thus releasing all resources associated with the call placed to the application server 38.

Meanwhile, the SSP 12 extracts the POTS number from the GAP of the Release message received in step 138 and uses the POTS number to formulate an IAM. In this example, the POTS number is the line occurrence address of the telephone 22. On consulting dialed number translation tables, the SSP 12 determines that the call should be routed over an ISUP trunk 26 which connects to the PSTN 25. The SSP 12 therefore formulates an IAM and consults link sets and route sets associated with the selected trunk group to address the IAM to the PSTN 25. Since the selected trunk group is not associated with the CCN 36, the IAM is forwarded (148) directly to PSTN 25. On receipt of the IAM, the PSTN 25 extracts the dialed number from the IAM and determines that the telephone set 22 is idle and available. Consequently, the PSTN 25 formulates an ACM message which it returns to SSP 12 (150), and applies ringing to the subscriber line for telephone 22 (152). On receipt of the ACM (150), the SSP 12 connects the Centrex subscriber 18 with the ISUP trunk 26 selected to carry the call, and the subscriber 18 hears ringing (154) generated by the PSTN 25. In response to the ringing (152), the called subscriber at telephone 22 takes the telephone 22 off-hook (156), which prompts PSTN 25 to formulate an Answer (ANM) message that is forwarded (158) to the SSP 12. Thereafter, conversation ensues between the Centrex subscriber 18 and the called party at telephone 22. After the conversation is completed, the called party 22, for example, goes on-hook (160). On receipt of the on-hook signal, the SSP formulates a Release message which it forwards through the signaling network to the SSP 12 (162). The SSP 12 responds by releasing the ISUP trunk and returning a Release Complete (RLC) message (164). Suspend messages have not been shown as they complicate the scenario without incremental explanation value. Thereafter, the SSP applies dial or all circuits busy tone (166) to the Centrex subscriber line which prompts the subscriber to return the telephone 18 on-hook (168).

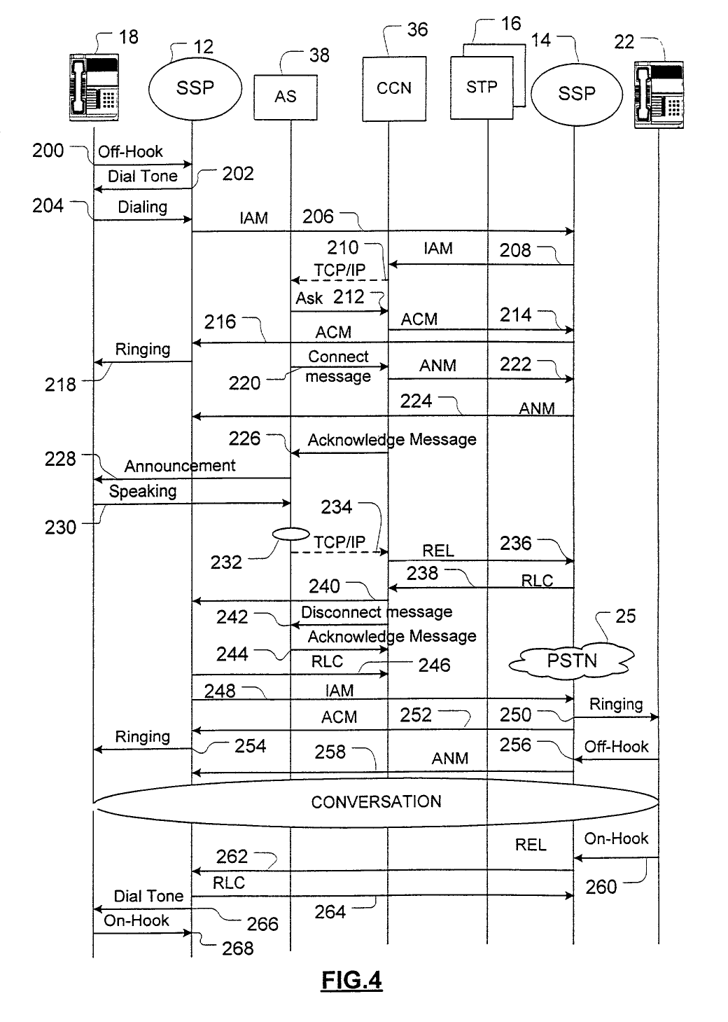

FIG. 3 shows a second network configuration in accordance with the invention. The elements shown in FIG. 3 are identical to those shown in FIG. 1 with the exception that the trunk which connects the application server 38 to the SSP 14 is a standard voice grade ISUP trunk group configured as an EISUP. Consequently, the CCN 36 is a logical switching node located between the SSP 14 and the application server 38. Because the application server 38 is not enabled for common channel signaling, the CCN 36 is equipped with an Application Programming Interface (API) to enable applications running on the application server 38 to be informed of call establishment and call release. This embodiment therefore eliminates the need for ISDN PRI trunks and ISDN PRI signaling capability on the application server 38. All control messages are passed from the CCN 36 to the application server 38 via data links 46, data network 44, and data link 42. A data protocol such as TCP/IP is preferably used for message transfer between the CCN 36 and the application server 38.

FIG. 4 is a call flow diagram of the principal messages exchanged between network components in a call example similar to that described above in which a Centrex subscriber using telephone 18 wishes to dial a service subscriber having telephone 20 using a voice-dialing capability enabled by the service resource implemented on application server 38. To initiate the call, the Centrex subscriber takes the telephone 18 off-hook (200). The SSP 12 responds to the off-hook condition by applying dial tone (202) to the line of telephone 18. On receiving dial tone, the Centrex subscriber presses a speed dial key, or any other function key enabled by the Centrex service programmed to initiate the voice-dialing feature (204). On receipt of the dialed digits, the SSP consults its routing tables and determines that the call should be routed over ISUP voice trunks (not illustrated) to SSP 14. A link set and route set associated with the voice trunk provide a Point Code Address of the SSP 14 to which call control messages are to be sent. The SSP 14 formulates an IAM containing the dialed digits and the destination Point Code of the SSP 14, and forwards the IAM (206) to the SSP 14 over the common channel signaling network. On receipt of the IAM, the SSP 14 consults its routing tables and determines that the IAM should be forward to the Point Code of the CCN 36. Consequently, the SSP 14 changes the origination and destination Point Codes in the IAM, in a manner well known in the art, and forwards the message to the CCN 36 (208). On receipt of the IAM, the CCN 36 examines the dialed number and determines that the IAM relates to a call to be terminated on the application server 38. The CCN 36 therefore extracts the Circuit Identification Code (CIC) from the IAM message and inserts it, along with other relevant information, in a setup message which it inserts into a TCP/IP message addressed to the application server 38, and forwards the message over the data network 44 to the application server 38 (210). On receipt of the setup message, the application server verifies the CIC and responds to the CCN with an Acknowledge (Ack) message returned through the data network 44 (212).

The Acknowledge message informs CCN 36 that the application server 38 is ready to accept the call in progress. Consequently, the CCN 36 returns an ACM message (214) to the SSP 14 which forwards the message to the SSP 12 (216). On receipt of the ACM, the SSP 12 may apply ringing to the telephone 18 (218). In the meantime, the application server 38 seizes the trunk member indicated by the CIC in the setup message received in step 210, and returns a Connect message (220) to the CCN 36. On receipt of the Connect message, the CCN 36 formulates an ANM message which it forwards to the SSP 14 (222). The SSP 14 relays the ANM message (224) to the SSP 12. Meanwhile, the CCN 36 sends an Acknowledge message through the data network 44 (226) to the application server 38, which prompts the application server 38 to announce to the Centrex subscriber at telephone 18 that it is ready to accept voice input for the voice-dialing service. As described above, the announcement (228) may be a simple tone or a pre-recorded voice message inviting the caller to speak the name of the party to be called, for example.

The caller responds to the announcement from application server 38 (228) by speaking the name (230) of the party desired to be called. On receipt of the voice input, the application server 38 performs a translation algorithm which compares the spoken name with a plurality of pre-recorded names (232) and retrieves routing information for completing the call, such as a POTS number as described above. The application server then forwards the routing information in a TCP/IP message sent over data network 44 to the CCN 36 (234). On receipt of the routing information, the CCN formulates an ISUP Release message containing a SAP and a GAP and forwards (236) the Release message to the SSP 14. On receipt of the Release message, the SSP 14 releases the CIC of ISUP trunk 50 used for the call and returns an RLC (238) to the CCN 36. The CCN 36 meanwhile forwards the Release message containing the SAP and the GAP (240) to the SSP 12. Meanwhile, on receipt of the RLC (238), the CCN 36 sends a Disconnect message to the application server 38 (242), and the application server 38 responds with an Acknowledge message (244) after releasing the CIC of the ISUP trunk 50 that was seized for call. On receipt of the Release message containing the SAP and GAP (240), the SSP 12 releases the voice trunk seized and returns an RLC (246) to the CCN 36. Thereafter, the SSP 12 extracts the POTS number from the GAP in the REL message and uses the POTS number to formulate an IAM message. Translation tables in the SSP 12 indicate that the IAM should be forwarded to the SSP 14 (248). On receipt of the IAM, the PSTN 25 consults its translation tables and determines optimum routing to the called telephone 22. On determining that the subscriber line for telephone 22 is idle, the PSTN 25 applies ringing to the line (250) and formulates an ACM message which is forwarded (252) to the SSP 12. On receipt of the ACM message, the SSP 12 connects the subscriber line for telephone 18 to the trunk circuit used to set up the call, and the called party hears the ringing (254) applied to subscriber line 22. In response to the ringing, the subscriber at telephone 22 takes the telephone off-hook (256), which prompts the PSTN 25 to formulate an Answer (ANM) message which it forwards (258) to the SSP 12.

Conversation between the two parties then ensues. After the conversation is completed, the subscriber at telephone 22 goes on-hook (260), which prompts the PSTN 25 to prepare a Release message which it forwards (262) to the SSP 12. On receipt of the Release message, the SSP 12 releases the trunk reserved for the call and formulates a RLC which it forwards (264) to the PSTN 25. Thereafter, SSP 12 applies dial tone (266) to the line of Centrex subscriber's telephone 18, which prompts the Centrex subscriber to place the telephone 18 on-hook (268), and call processing is completed.

As is evident from the two simple examples described above, calls are efficiently forwarded through the network without redundant circuits. Furthermore, the service resource (application server 38, for example) is liberated for use by other parties as soon as its function is completed. Consequently, trunk facilities and service resources in the network are efficiently used. Although the invention has been explained with reference to a voice-dialing feature enabled for Centrex subscribers, it should be understood that the methods and apparatus in accordance with the invention are in no respect limited to that application. The invention may be used for efficient use of the voice trunks for accessing any service resource in the switched telephone network from which calls are advantageously forwarded to another termination. It should also be understood that unlike prior art release functions, the invention enables an injection of a release condition through a virtual switching node adapted to serve distributed, centralized or enterprise applications.

The methods and apparatus in accordance with the invention described above are intended to be exemplary only. The scope of the invention is therefore intended to be limited solely by the scope of the appended claims.

We claim:

1. A method of efficiently using facilities for providing dial-up access to a service resource in a switched telephone network, comprising the steps of:
receiving information at the service resource from a calling party, the information being related to a service supported by the service resource;
translating the information into routing information that can be used to connect the calling party to a call termination associated with the service;
transmitting the routing information to a call control node in the switched telephone network, the call control node being a virtual switching node in a switching plane and a physical node in a control plane of the switched telephone network; and
formulating at least one control message at the call control node to release the facilities used by the calling party to access the service resource, and to connect the calling party to the call termination without disconnecting the calling party form the switched telephone network.

2. The method as claimed in claim 1 wherein the call control node is configured as a virtual node in an ISDN User Part (ISUP) trunk group in a call path between the user and the service resource.

3. The method as claimed in claim 2 wherein the ISUP trunk group is a trunk group that connects the service resource to a switching node in the switched telephone network.

4. The method as claimed in claim 2 wherein the ISUP trunk group is an inter-switch trunk group in the switched telephone network.

5. The method as claimed in claim 2 wherein the ISUP trunk group is a loop-back trunk group connected to a switching node in the switched telephoned network, the loop-back trunk group being in the call path.

6. The method as claimed in claim 1 wherein the at least one control message is at least one common channel signaling message comprising an ISUP Release message with Cause set to Normal Clearing.

7. The method as claimed in claim 6 wherein the Release message causes the dial-up facilities used by the calling party to access the service resource to be released back to a switching office that serves the calling party, and the a first parameter in the Release message causes the switching office that serves the calling party to initiate a new call using a second parameter in the Release message, the second parameter containing routing information for connecting the calling party to the call termination.

9. The method as claimed in claim 1 wherein the step of transmitting involves sending the routing information from the service resource to the call control node via a data network.

10. The method as claimed in claim 9 wherein the data network is a Transmission Control Protocol/Internet Protocol (TCP/IP) network.

11. Apparatus for efficiently utilizing dial-up facilities for accessing a service resource in a switched telephone network, comprising:
a call control node in the switched telephone network, the call control node being a virtual node in a switching plane and a physical node in a control plane of the switched telephone network, the call control node being adapted to receive messages containing routing information, to initiate actions to release the facilities utilized by the calling party to access the service resource, and to initiate actions to use the routing information to connect the calling party to a call termination identified by the routing information without releasing the calling party from the switched telephone network; and
the service resource being adapted to receive information from a user that can be translated into routing information for completing a call between the user and a termination associated with a service supported by the service resource, and to send a message containing the routing information to the call control node.

12. Apparatus as claimed in claim 11 wherein the call control node includes an interface for connection to a data network.

13. Apparatus as claimed in claim 12 wherein the service resource also has an interface for connection to the data network and the data network is used to send the messages containing routing information from the service resource to the call control node.

14. Apparatus as claimed in claim 13 wherein the data network is a Transmission Control Protocol/Internet Protocol (TCP/IP) network.

15. Apparatus as claimed in claim 12 wherein the call control node is programmed to formulate a control message on receipt of the routing information, the control message being used to release the facilities used by the calling party to access the service resource.

19. Apparatus as claimed in claim 12 wherein the control message is a common channel signaling message and the common channel signaling message is an ISDN User Part (ISUP) Release message with a Cause set to Normal Clearing.

20. Apparatus as claimed in claim 19 wherein the Release message also contains a first parameter that causes the switching point that serves the called party to initiate a second call after the call to the service resource is released, and second parameter used to provide a termination address for the second call.

21. Apparatus as claimed in claim 20 wherein the call control node is adapted to insert the routing information into the second parameter and the routing information in the second parameter is used by the switching node that serves the calling party to formulate an ISUP Initial Address Message (IAM) to connect the calling party to the call termination after the facilities used by the calling party to access the service resource have been released.

22. Apparatus as claimed in claim 12 wherein the call control node is provisioned to receive all ISUP call control messages related to calls placed to the service resource.

23. Apparatus as claimed in claim 22 wherein the call control node is adapted to alert the service resource of an incoming call on the trunk group on receipt of an IAM from a switching node to which the trunk group is connected.

24. Apparatus as claimed in claim 23 wherein the call control node is adapted to alert the service resource by transmitting an information message to the service resource using a data network.

25. Apparatus as claimed in claim 24 wherein the call control node includes an Application Programming Interface (API) used to communicate with the service resource.
